(19) United States
(12) Patent Application Publication
(10) Pub. No.: US 2008/0238067 A1
(43) Pub. Date: Oct. 2, 2008

(54) AUTOMOBILE PROTECTION SYSTEM

(76) Inventor: Graeme A. Gordon, Dallas, TX (US)

Correspondence Address: ANDERSON, LEVINE & LINTEL L.L.P., 14785 PRESTON ROAD, SUITE 650, DALLAS, TX, 75254, US

(21) Appl. No.: 11/862,773

(22) Filed: Sep. 27, 2007

Related U.S. Application Data
(60) Provisional application No. 60/829,563, filed on Oct. 16, 2006.

(51) Int. Cl. B60J 11/06

(52) U.S. Cl. 280/770

(57) ABSTRACT

A door protection system can be attached to a ceiling or wall. When attached to a ceiling, the clear pad is coupled to the ceiling though safety releases. Each safety release couples a first rope attached to the pad in an inverted “V” configuration to a vertical disposed rope secured to the ceiling. The safety releases are at a height so that they can be reset or replaced without a ladder. The inverted “V” shape allows the vertically disposed rope to be placed in a position which will not significantly interfere with the garage door as it is opened. Tubes prevent the vertically disposed rope from catching with the garage door opener rail or carriage. A partially threaded screw is adaptable to both anchor or stud/joist installations.

### CROSS-REFERENCE TO RELATED APPLICATIONS

This application claims the benefit of the filing date of copending provisional application U.S. Ser. No. 60/829,563, filed Oct. 16, 2006, entitled “AUTOMOBILE PROTECTION SYSTEM”, which is incorporated by reference herein.

### STATEMENT OF FEDERALLY SPONSORED RESEARCH OR DEVELOPMENT

Not Applicable

### BACKGROUND OF THE INVENTION

1. Technical Field

This invention relates in general to motor vehicle protection devices and, more particularly, to a system for protecting motor vehicles from contact with adjacent vehicles and garage walls.

2. Description of the Related Art

In parking garages, either residential garages or commercial parking garages, there is seldom enough room to fully open a car door, if an adjacent parking space is occupied. As a result, a car door often presses against the adjacent automobile (or other motor vehicle or object) or a wall while the occupants exit the vehicle; if the occupants are not careful opening the door, contact between the cars can cause scratches, dings and dents in both motor vehicles, or to the wall or other objects.

Over the years, many solutions have been proposed. Among the various shortcomings of these solutions include the expense of the systems, bulkiness, difficulty of installation and safety considerations.

One particular problem concerns release of the pad when it is impacted. In most cases, the pad will slide along the object with which it is in contact; however in certain situations, the pad becomes caught up with the object, and the force of the object will pull the pad away from its point of attachment. In some devices, safety releases are used at the point of contact (generally at the garage ceiling). However, once the pad is released, the user is forced to use a ladder to re-attach the pad at the ceiling. This can be bothersome, especially for older users. If a safety device is not used, the attachment hardware can pull from the ceiling—this can cause damage if the attachment hardware falls on the automobile or other valuable object and may require an expensive repair to the ceiling.

Therefore, an improved system for protecting automobiles in a parking garage is needed.

### BRIEF SUMMARY OF THE INVENTION

In the present invention, a vehicle exterior protection system comprises a pad having at least two pairs of attachment points. At least two vertically disposed ropes with upper and lower ends are coupled to a ceiling. Safety releases couple the lower ends of the vertically disposed ropes to one or more pad connection ropes connecting the pad attachment points, such that the pad connection ropes form an inverted “V” shape with the safety release, with the vertex of the “V” at the safety release.

### BRIEF DESCRIPTION OF THE SEVERAL VIEWS OF THE DRAWINGS

For a more complete understanding of the present invention, and the advantages thereof, reference is now made to the following descriptions taken in conjunction with the accompanying drawings, in which:

FIG. 1 illustrates a perspective view of a door protection system between two automobiles in a garage;

FIG. 2 illustrates a side view of the door protection system of FIG. 1 as attached to a ceiling;

FIG. 3 illustrates a screw used to connect the door protection system to a wall or ceiling;

FIG. 4 illustrates a tube used to preventing the door protection device from interaction with a garage door opener; and

FIGS. 5a and 5b illustrate an embodiment where the door protection device is coupled to a wall.

### DETAILED DESCRIPTION OF THE INVENTION

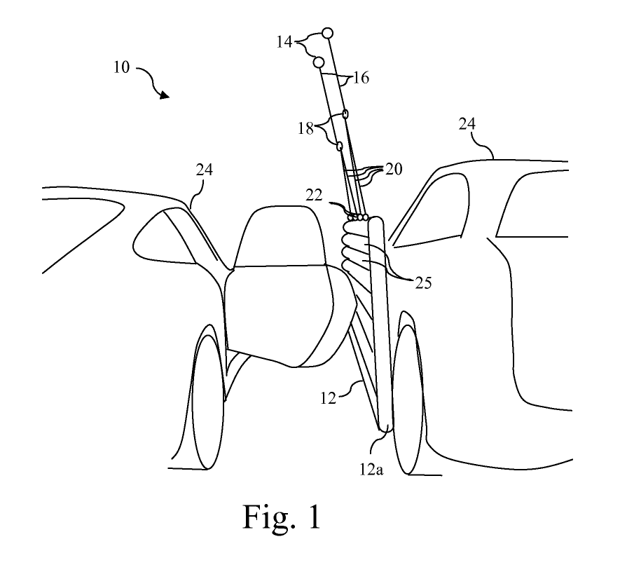

The present invention is best understood in relation to FIGS. 1-5a-b of the drawings, like numerals being used for like elements of the various drawings.

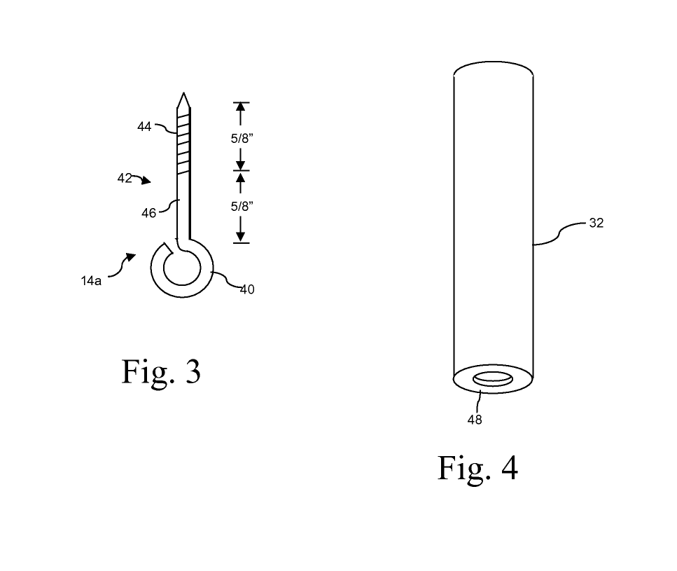

FIG. 1 illustrates a first embodiment of door protection device 10 the present invention, with the pad 12 attached to the ceiling. The pad 12 is hung from the ceiling using screw/anchor systems 14 (shown in greater detail in connection with FIG. 3. The screw/anchor systems 14 provide a secure attachment to the ceiling, either using an anchor in the ceiling drywall, or screwing through the drywall into a joist. Ropes 16 connect the screw/anchor systems 14 to safety releases 18. Two (or more) ropes 20 are coupled at both ends at connection points 22, with the rope threaded through the safety releases 18, forming an inverted “V”.

FIG. 1 illustrates the pad 12 positioned between two automobiles 24. As one of the automobile doors is opened, the pad 12 protects both automobiles from impact resulting in the door opening. However, in unusual circumstances, the pad 12 and/or ropes could become caught in a foreign object, such as a protruding object attached to the roof of the car, or in a circumstance that doesn't involve a motor vehicle at all. In the unusual event that the pad 12 or ropes are pulled with a significant force, one or more of the safety releases 18 will release the respective rope 20 from rope 16, preventing the ropes 16 from pulling out the screw/anchor systems 22. The safety releases 18 could then be reset or replaced, depending upon the nature of operation of the safety releases 18. In the preferred embodiment, the releases cannot be reset, in order to prevent a damaged release from being used. In the preferred embodiment, the safety releases are at a vertical height of 92 inches or less.

In the preferred embodiment, the pad is inflatable using “I-beam” construction where air is encased in long inflatable cylinders 25 (in the preferred embodiment, the cylinders are connected such that only one inflation valve is necessary to inflate the pad). I-beam construction allows the pad to be thinner, while maintaining a protective cushion. For safety reasons, the sidewalls of pad are made from a relatively clear material, such as a clear vinyl, so that a person opening a car door can identify objects on the other side of the pad 12. The gusset 12a at the front or back the pad is made from a colored material, such as vinyl, to aid in the driver's visual detection of the pad during parking.

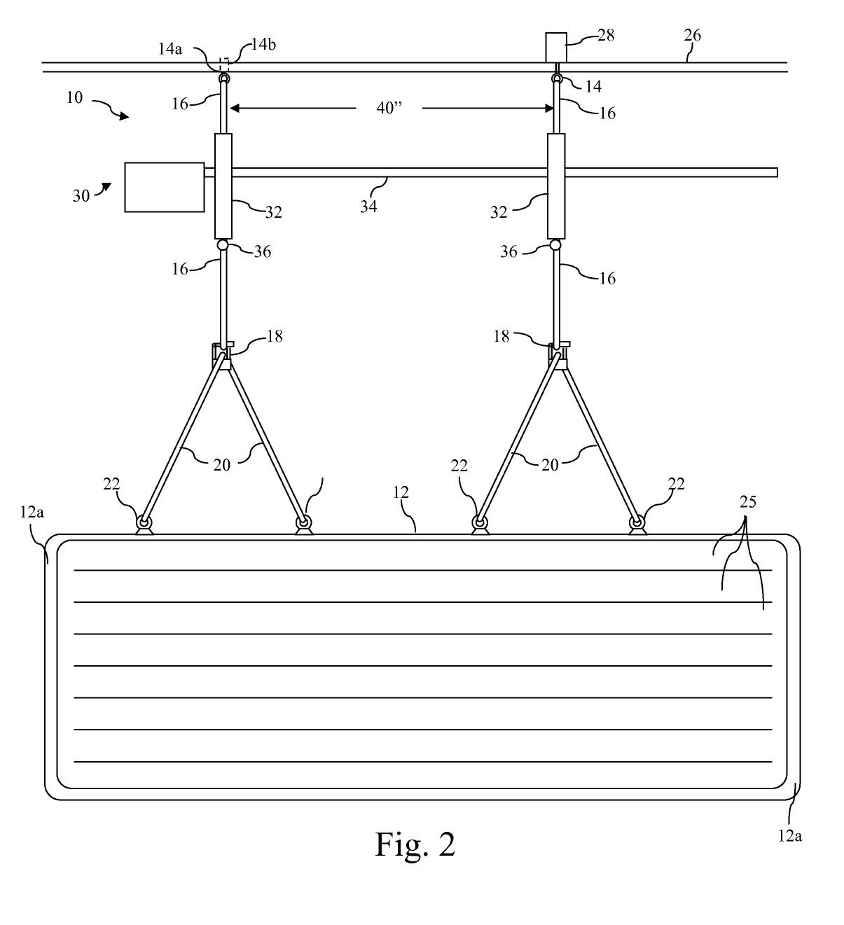

FIG. 2 illustrates a side view of a preferred embodiment of the invention as installed in a ceiling mount. In the illustrated embodiment, the left screw/anchor uses a screw 14a with an anchor 14b mounted in the ceiling drywall 26. The right screw/anchor 14 uses just the screw 14a mounted through the ceiling drywall 26, into a joist 28. When mounting the door protection device 10 near a door opener 30, ropes 16 are disposed through clear plastic tubes 32 around the position of the garage door opener rail or carriage 34. Tubes 32 may be held in place by a knot or adjustable collar 36.

The end of rope 16 opposite the ceiling attachment has a loop which is connected to plastic safety release 18. Similarly rope 20 passes through safety release 18. Safety release 18 can be, for example, a security seal of the type shown in U.S. Pat. No. 4,506,921 to Swift, which is incorporated by reference herein. A device of this type uses a stud and socket combination, which releases when a disengaging force is applied. When the stud and socket release, rope 16 is uncoupled from rope 20 (for the relevant safety release), preventing any force on the pad 12 from being transferred to the associated screw/anchor 14. In the preferred embodiment, the safety release 18 disengages at approximately 11 pounds of pull force.

The inverted “V” shapes of ropes 20 allow the pad 12 to be positioned to run the length of both doors on the side of most automobiles, while providing clearance between the front-most rope 16 and the garage door in an open position.

FIG. 3 illustrates a preferred embodiment of the screw 14a used in the screw/anchors 14. The screw 14a includes an eye 40, integrally coupled to a shaft 42. Shaft 42 has threaded portion 44 for about one-half of its length, with the other half of the shaft (nearest the eye 40) being a smooth portion 46. Both the threaded portion 44 and smooth portion 46 are approximately ⅝″ in length. The screw 14a provides significant advantages. When used with an anchor, the screw gives a visual indication of when the screw is fully in the anchor, as the smooth part will be at the top of the anchor. When used to attach the pad 12 to a joist 28, the helical portion of the screw will be fully in the joist 28 when the eye is flush with the ceiling (assuming a typical drywall thickness of ⅜ to ⅝″).

FIG. 4 illustrates a perspective view of a tube 32. Tube 32 is preferably made from a suitable plastic material. At the bottom of tube 32, there is a plastic welded plastic end-cap 48 to reduce the diameter of the tube such that it can be held in place by a knot or adjustable collar on the rope 16 place just below the welded plastic end-cap 48.

Importantly, anything that could come in contact with an automobile, either during normal operation or due to release by the safety release 18, is made of plastic, rope, or synthetic rope, or other suitably soft material, such that anything that hits the car will cause minimal or no damage to the automobile, including scratches to the paint.

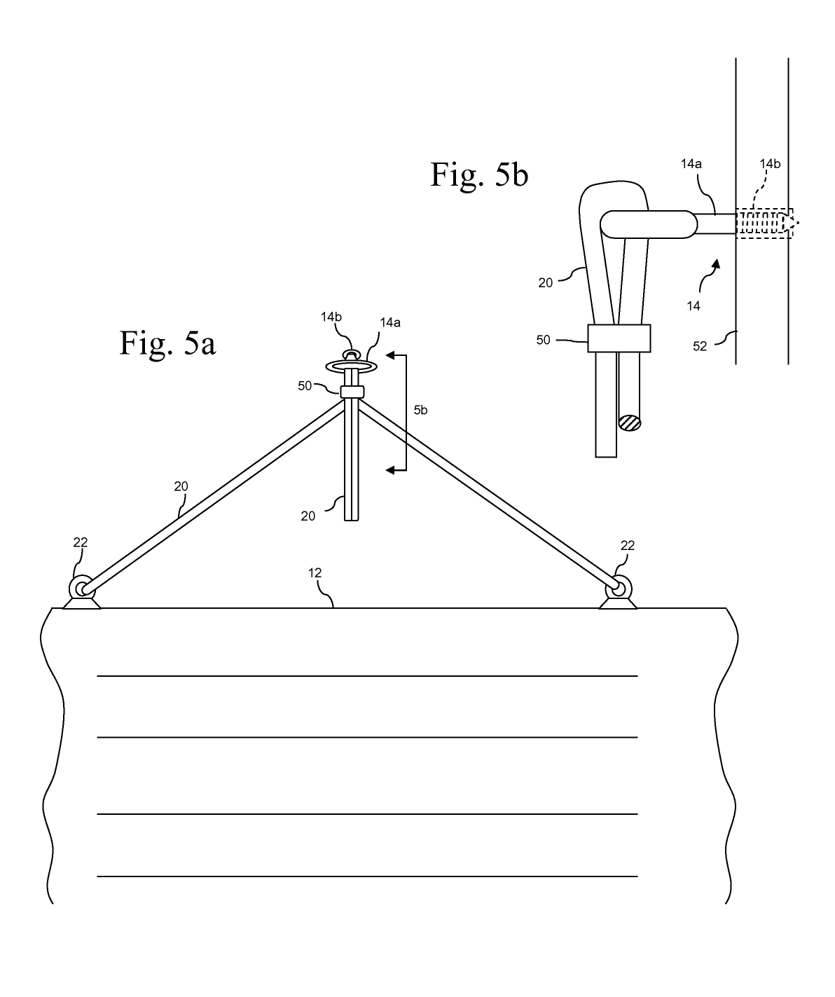

FIGS. 5a and 5b illustrate the pad 12 coupled to a wall 52. In this embodiment ropes 20 are coupled directly through the eyes of screws 14a. Screw 14a can be connected to the wall by an anchor 14b or to a stud (not shown) as described above. A zip tie 50, or other suitable device, is used to hold rope 20 at its desired height relative to the placement of the screws 14a. By pulling more of the rope 20 through the screws 14a, the pad 12 is raised; pulling less rope through the screws 14a lowers the pad 12.

The present invention provides significant advantages over the prior art. First, the pad may be hung from the ceiling without substantial interference with a garage door and without resorting to bulky structures attached to the ceiling to provide clearance for the garage door. Second, safety releases are provided at locations where they can be easily reset or replaced. Third, no metal or hard plastic pieces are necessary, which could scratch or dent the automobile exterior. Fourth, a screw is provided which is easily used for both anchor and joist/stud installations. Fifth, no bulky items are used, so the entire device can be placed in a small package for shipping. Sixth, tubes prevent potentially dangerous interaction with a garage door opener. Seventh, the pad can be used in both wall and ceiling installations using the same installation hardware.

Although the Detailed Description of the invention has been directed to certain exemplary embodiments, various modifications of these embodiments, as well as alternative embodiments, will be suggested to those skilled in the art. The invention encompasses any modifications or alternative embodiments that fall within the scope of the Claims.

1. A vehicle exterior protection system comprising:
a pad having at least two pairs of pad attachment points;
at least two vertically disposed rope segments having upper and lower ends, with the upper end coupled to a ceiling attachment device;
safety releases coupled to the lower ends of the vertically disposed rope segments; and
at least two pad connection rope segments each coupling a pair of attachment points to a respective safety release, such that the pad connection rope segments form an inverted “V” shape with each safety release, with the vertex of the “V” at the safety release.

2. The vehicle exterior protection system of claim 1 and further comprising tubes disposed about the vertically disposed rope segments to prevent interaction with a garage door opener.

3. The vehicle exterior protection system of claim 2 wherein the tubes are clear.

4. The vehicle exterior protection system of claim 1 wherein the pad is at least partially clear so that objects on the other side of the pad can be seen.

5. The vehicle exterior protection system of claim 1 wherein the ceiling attachment devices include a screw with a partially threaded shaft.

6. The vehicle exterior protection system of claim 1 wherein each safety release uncouples the vertically disposed rope segment from the pad connection rope segment with a pull force of approximately 11 pounds.

7. The vehicle exterior protection system of claim 1 where the safety releases are positioned at a height of 92 inches or less.

8. The vehicle exterior protection system of claim 1 wherein the pad is inflatable.

9. The vehicle exterior protection system of claim 8, wherein the inflatable pad includes multiple inflatable cylinder portions.

10. The vehicle exterior protection system of claim 1 wherein the pad has substantially transparent sidewalls such that a car occupant can detect objects on the other side of the pad.

11. The vehicle exterior protection system of claim 10 wherein the pad has a colored gusset portion between the sidewalls.

12. A vehicle exterior protection system comprising:
a pad having at least two pairs of pad attachment points;
at least two vertically disposed rope segments having upper and lower ends, with the upper end coupled to a ceiling attachment device;
at least two pad connection rope segments coupling a pair of attachment points to a respective safety release, such that the pad connection rope segments form an inverted “V” shape with each safety release, with the vertex of the “V” at the safety release; and
two or more screws for selectively mounting the pad to either a wall or a ceiling.
